(19) United States
(12) Patent Application Publication
(10) Pub. No.: US 2026/0077380 A1
(43) Pub. Date: Mar. 19, 2026

(54) DEVICE FOR CONVEYING VISCOUS MATERIAL

(71) Applicant: Atlas Copco IAS GmbH, Bretten (DE)

(72) Inventors: Bastian ROTH, Kämpfelbach (DE); Sten MITTAG, Karlsruhe (DE); Bernhard SAUER, Ölbronn-Dürrn (DE)

(73) Assignee: Atlas Copco IAS GmbH, Bretten (DE)

(21) Appl. No.: 18/996,023

(22) PCT Filed: Jul. 6, 2023
(86) PCT No.: PCT/EP2023/068690

§ 371 Date: Jan. 17, 2025

(30) Foreign Application Priority Data
Jul. 21, 2022 (DE) 10 2022 118 228.2

(51) Int. Cl. B05C 11/10

(52) U.S. Cl. CPC B05C 11/1013; B05C 11/1028

(57) ABSTRACT

A device for conveying viscous material to an applicator has a conveying cylinder in which a double-acting conveying piston is movable to and fro. The conveying cylinder has first and second chambers separated from one another by the conveying piston. Each chamber has a material inlet and outlet. A conveying device is connected to the material inlets for the pressurized introduction of viscous material into the conveying cylinder chambers, and a valve device closes and opens the material inlets and outlets. In a first switching position, the valve device opens the first chamber material inlet and the second chamber material outlet and closes the second chamber material inlet and the first chamber material outlet and, in a second switching position, releases the second chamber material inlet and the first chamber material outlet and closes the first chamber material inlet and the second chamber material outlet.

The invention relates to an apparatus for conveying viscous material to an applicator, in accordance with the preamble of claim 1, as well as to a regulation apparatus in accordance with the preamble of claim 10, which is preferably used with the apparatus.

Such apparatuses are generally used in industrial production, in particular in the automobile industry, where workpieces are coated with viscous material, for example with adhesive, sealant, insulation material, TIM material or heat-conductive paste. They serve to convey the viscous material to an applicator that then meters the viscous material and applies it to the workpiece in question. Such apparatuses are generally large in construction and very heavy, wherein nevertheless endless conveying of the viscous material often can take place only insufficiently. Furthermore, conventional apparatuses of the type stated initially often do not allow active pressure regulation.

It is therefore the task of the invention to further develop an apparatus and an applicator of the type stated initially, in such a manner that the aforementioned disadvantages are avoided, at least in part, to a great extent.

This task is accomplished, according to the invention, by means of an apparatus having the characteristics of claim 1, as well as by means of a regulation apparatus having the characteristics of claim 10 and/or of claim 16. Advantageous further developments of the invention are the object of the dependent claims.

The conveying apparatus according to the invention is based on the idea of displacing, by means of pressure-impacted filling of the one chamber of the conveying cylinder, the material situated in the other chamber, in each instance, and conveying it to the applicator through the material outlets that lead to the applicator, directly or indirectly. As soon as the latter chamber has been emptied, the principle is reversed, and the emptied chamber is filled with the viscous material, under the impact of pressure, so that the material is displaced out of the former chamber and conveyed to the applicator. This method allows almost endless conveying with minimization of downtimes.

It is preferred that the valve device has a valve housing and a slider that can move back and forth in the valve housing, wherein the valve housing and the slider define a pass-through channel that can be closed and opened for each of the material inlet openings and for each of the material outlet openings. In the first switching position of the valve device, the slider opens the pass-through channels of the material inlet of the first chamber and of the material outlet of the second chamber, and closes the pass-through channels of the material inlet of the second chamber and of the material outlet of the first chamber. In the second switching position of the valve device, the slider opens the pass-through channels of the material inlet of the second chamber and of the material outlet of the first chamber, and closes the pass-through channels of the material inlet of the first chamber and of the material outlet of the second chamber. Using the slider, then only one movable component needs to be provided and moved during operation, so that the apparatus can have a smaller and/or lighter construction than conventional apparatuses. Also, control of the valve device is easier than in the case of conventional apparatuses of the type stated initially, since fundamentally, the slider only has to be pushed back and forth between its two positions that define the switching positions of the valve device.

Preferably, the slider has a cylindrical shape and, in particular, the shape of a circular cylinder, in other words it has a circular cross-section, which promotes easy displaceability. Furthermore, it is preferred that the valve device has a sleeve that is inserted into the valve housing, into which sleeve the slider is inserted with precise fit. The precise-fit insertion of the slider into the sleeve leads to a satisfactory seal, so that if applicable, it is possible to do without further sealing elements between the slider and the sleeve. It is practical if such sealing elements, in particular elastomer sealing rings, are inserted between the sleeve and the housing, and seal the pass-through channels off from one another. Since the sleeve is immovably held in the valve housing, the sealing rings are not subject to any movement-related wear. It is furthermore practical if the valve housing has multiple parts, with several housing parts set against one another in the axial direction, which parts are preferably firmly connected to one another. This measure facilitates assembly, in particular insertion of the sealing rings between the valve housing and the sleeve during assembly of the valve device.

It is advantageous if a path measurement sensor is provided for detection of the position of the conveying piston in the conveying cylinder. The path measurement sensor can be a mechanical sensor that measures the movement of a piston rod that projects out of the conveying cylinder. However, it is preferred that the path measurement sensor has a permanent-magnet element that is firmly connected to the conveying piston, and a magnetostrictive element that is firmly connected to the conveying cylinder. An evaluation unit is provided, which evaluates the magnetostriction induced by the permanent-magnet element in the magnetostrictive element. In this embodiment, it is not necessary to guide a piston rod out of the conveying cylinder, requiring complicated sealing, and the position of the conveying piston in the conveying cylinder can be measured with great accuracy. It is advantageous to use the measurement of the position of the conveying piston in the conveying cylinder to control the valve device and/or a conveying pump of the conveying device, so as to meter the viscous material even before it is passed to the applicator. For this purpose, it is practical if a control unit is provided, which receives position data from the path measurement sensor and controls the valve device and/or the conveying pump as a function of the position data, so as to achieve the most continuous material flow possible. In particular, the path measurement sensor can detect when one of the chambers has been almost completely emptied, so that the control unit can control the valve device so as to bring it into a different switching position by means of moving the slider.

Furthermore, it can be provided that the valve device opens both material outlets and/or both material inlets, at least in part, in at least one intermediate position. In particular, one of the material outlets is already opened then, while the other material outlet is not yet completely closed, so that downtimes can be further minimized.

The regulation apparatus according to the invention, according to claim 10, is based on the idea of making opening and closing of the regulation valve possible precisely and with great time resolution, in that an actuator is provided for impacting the closing element. Since conventional actuators often can apply either a great force but only a slight travel, or, vice versa, a slight force but a great travel, a force transfer element is provided, which is connected to the closing element at a connection point and impacted by the actuator at an impaction point.

According to an advantageous embodiment, the force transfer element is a lever that is mounted in or on the housing so as to pivot about a pivot axis. The actuator can be a piezo-actuator, which can apply a great force but only a slight travel. In order to increase the travel of the closing element, the impaction point then lies closer to the pivot axis than the connection point does, wherein the distance of the connection point is preferably at least five times and even more preferably at least eight times as great as the distance of the impaction point from the pivot axis. The lever can have one arm or two arms. In the latter case, the connection point is arranged at or close to the free end of the longer lever arm, while the impaction point is arranged on the shorter lever arm. If the lever has only one arm, the connection point is situated at or close to the free end of the lever arm, while the impaction point is situated on the same lever arm, in the vicinity of the pivot axis.

According to a further possible method of construction, the actuator has a plunger coil or voice coil, which can exert a great travel but only a slight force. In order to increase the force that acts on the closing element, the connection point then lies closer to the pivot axis than the impaction point does, wherein the distance of the impaction point is preferably at least five times and further preferably at least eight times as great as the distance of the connection point from the pivot axis. In this case, as well, the lever can have one arm or two arms, wherein here the two-arm embodiment is preferred.

According to an advantageous embodiment, the force transfer element is a hydraulic element and the actuator is a piezo-actuator. By means of corresponding cross-sections of the hydraulic element at the connection point and at the impaction point, the great force applied by the piezo-actuator can be converted into a sufficient travel at the closing element.

Alternatively or supplementally to this measure according to the invention, a pressure sensor for measuring the pressure of the viscous material can be arranged in the material line of the regulation apparatus. In this regard, it is practical if the pressure sensor is arranged downstream after the valve seat, and thereby measures the pressure of the viscous material as it flows out of the regulation valve. On the basis of this pressure measurement, the pressure of the viscous material can be regulated to a reference value. For this purpose, it is preferable if the pressure sensor is connected to a regulation unit, which regulates the pressure of the viscous material at the pressure sensor to the reference value by means of controlling the actuator as a function of the pressure measured by the pressure sensor.

The regulation apparatus according to the invention, together with the apparatus according to the invention for conveying viscous material and an applicator that has a nozzle having at least one exit opening for the viscous material, preferably forms an apparatus for applying viscous material to workpieces, in which the material outlets of the apparatus for conveying viscous material are connected, on the inlet side, with the material line of the regulation apparatus, and in which the material line is connected, on the outlet side, with the applicator. This apparatus is operated, according to a preferred method, in such a manner that the regulation unit for controlling the actuator regulates the pressure of the viscous material at the pressure sensor to a reference value as a function of the pressure measured by the pressure sensor. Supplementally or alternatively to the aforementioned method step, it is provided that the control unit controls the valve device and/or the conveying pump so as to achieve a continuous material flow. If a multi-component material is supposed to be applied, an apparatus according to the invention, for conveying viscous material, and a regulation apparatus according to the invention are provided for each of the components, wherein the the material outlets of the apparatus for conveying viscous material are connected, on the inlet side, to the material line of the regulation apparatus, and wherein the material lines are connected, on the outlet side, to a common applicator that furthermore has a mixer for mixing the components.

In the following, the invention will be explained in greater detail using an exemplary embodiment shown schematically in the drawing. The figures show:

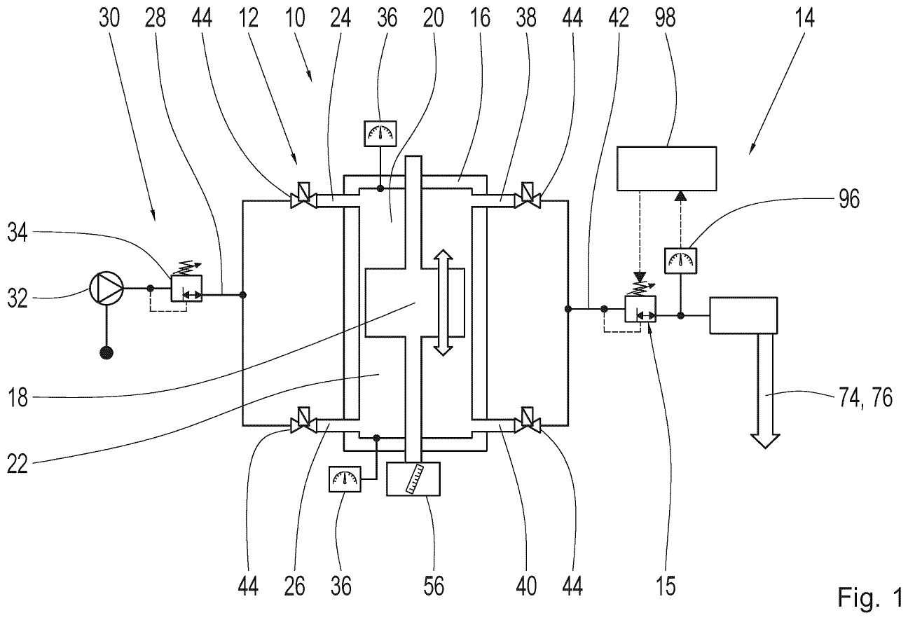

FIG. 1 a schematic representation of an apparatus for applying viscous material;

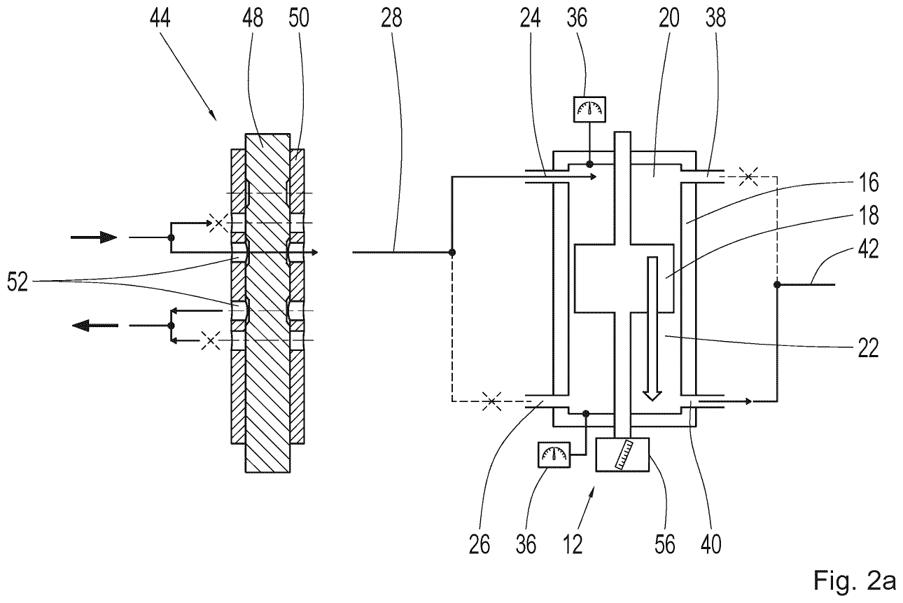

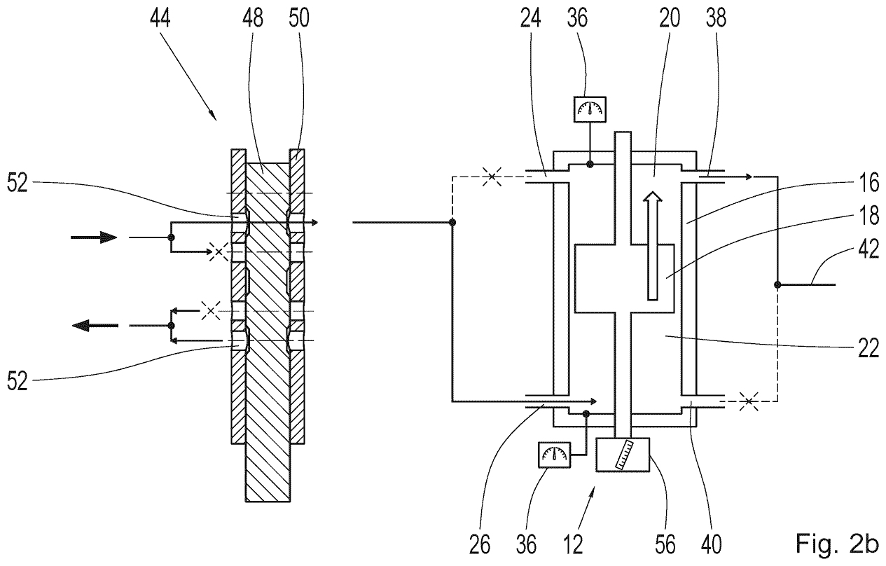

FIGS. 2a, 2b a schematic representation of an apparatus for conveying viscous material as a component of the apparatus according to FIG. 1, as well as a part of a valve device in a sectional representation, in a first and a second switching position;

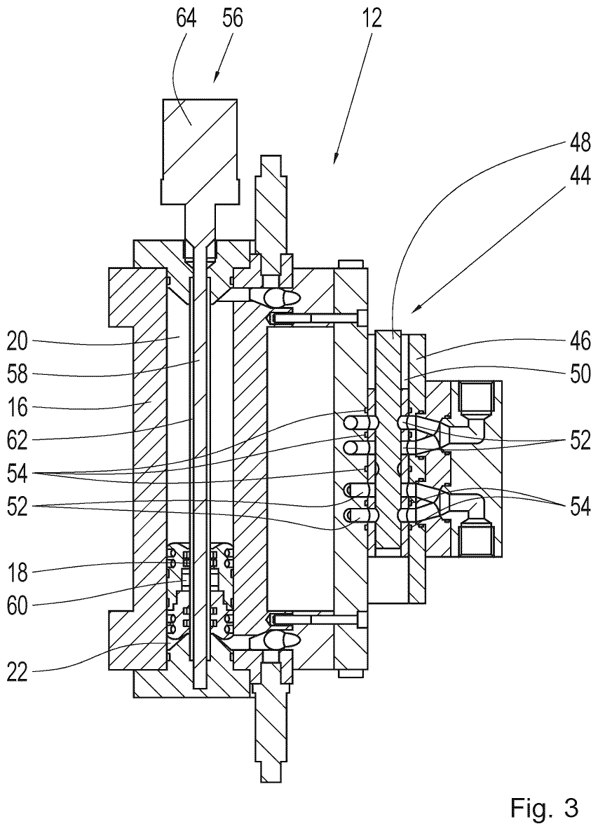

FIG. 3 a partial view of the apparatus according to FIGS. 2a, 2b, in section, and

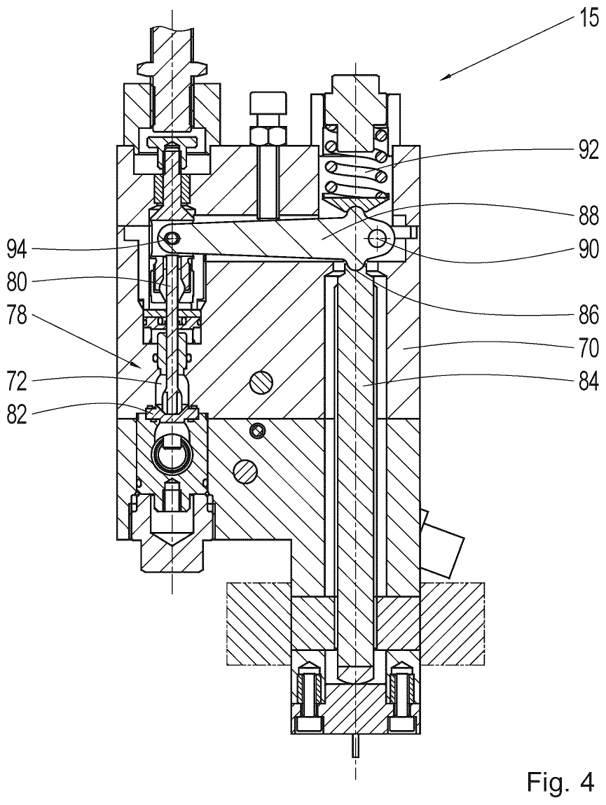

FIG. 4 a regulation apparatus of the apparatus according to FIG. 1, in section.

The apparatus 10 for applying a viscous material to workpieces, shown in the drawing, in short application apparatus 10, has an apparatus 12 for conveying the viscous material, in short conveying apparatus 12, an applicator 14 to which the conveying apparatus 12 conveys the viscous material and which applies the viscous material to the workpieces, as well as a regulation apparatus 15 that regulates the material flow from the conveying apparatus 12 to the applicator 14 and/or the material pressure. Differing from what is shown in the drawing, the regulation apparatus 15 and the applicator 14 can also be jointly integrated into a housing and form a module.

The application apparatus 10 shown in the drawing serves for applying a single-component viscous material to workpieces. If a multi-component material is to be applied to workpieces, a corresponding application apparatus would have to be equipped with a number of conveying apparatuses 12 and regulation apparatuses 15 that corresponds to the number of components, each of which passes one of the components, in each instance, to a common applicator 14, which then also has a mixer for mixing the components.

The conveying apparatus 12 has a conveying cylinder 16 in which a conveying piston 18 can move back and forth. The conveying piston 18 divides the interior of the conveying cylinder 16 into a first chamber 20 and a second chamber 22, which is sealed off relative to the second chamber by means of the conveying piston 18, which chambers are variable in size on the basis of the mobility of the conveying piston 18, in each instance. The first chamber 20 has a first material inlet 24, while the second chamber 22 has a second material inlet 26. Both material inlets 24, 26 are connected to a conveying device 30 by way of a conveying line 28, which device has a conveying pump 32 and a pressure regulator 34. The conveying pump 32 makes the energy potential for the application apparatus 10 available. A first pressure sensor 36 for measuring the pressure of the viscous material is arranged in each of the chambers 20, 22. The first chamber 20 furthermore has a first material outlet 38, while the second chamber 22 has a second material outlet 40, wherein a feed line 42 leads from the material outlets 38, 40 to the applicator 14 by way of the regulation apparatus 15.

By means of a movement of the conveying piston 18, viscous material can be displaced out of the chamber 20, 22, which decreases in size as the result of the movement of the conveying piston 18, so that this material can be conveyed out of the material outlet 38, 40 in question into the feed line 42. Such a movement of the conveying piston 18 is achieved, in the present case, in that the viscous material is introduced into the other chamber 20, 22, in each instance, under the impact of pressure. For this purpose, a valve device 44 is provided, which opens the first material inlet 24 and blocks the second material inlet 26 in a first switching position (FIG. 2a), and, at the same time, blocks the first material outlet 38 and opens the second material outlet 40. In a second switching position (FIG. 2b) this principle is reversed, and the valve device 44 opens the second material inlet 26 and the first material outlet 38 and blocks the first material inlet 24 and the second material outlet 40. In this manner, viscous material is constantly introduced, at most interrupted by short downtimes, into one of the chambers 20, 22, under the impact of pressure, by way of the material inlet 24, 26 in question, and the viscous material that is situated in the other chamber 20, 22, in each instance, is conveyed through the related material outlet 38, 40 into the feed line 42 and thereby to the applicator 14.

Contrary to the schematic representation in FIGS. 1, 2a, 2b, the material inlets 24, 26 and the material outlets 38, 40 are not arranged on different sides of the conveying cylinder 16, but rather on one side, or the corresponding lines extend to one side, so that the valve device 44 can be configured in accordance with the sectional representations in FIGS. 2a, 2b, 3. The valve device 44 has a valve housing 46 that is only shown in FIG. 3, in which a slider 48 is guided so as to be displaced back and forth. As is also evident from the detail representation of FIG. 3, a sleeve 50 is also inserted between the valve housing 46 and the slider 48, which sleeve is also shown in FIGS. 2a, 2b, and accommodated in the valve housing 46 so as not to move, and in which the slider 48 is accommodated, displaceable with precise fit. The valve housing 46, the slider 48, and the sleeve 50 define a pass-through channel 52 for each of the material inlets 24, 26 and for each of the material outlets 38, 40, which channel can be blocked or opened by means of corresponding positioning of the slider 48 in the valve housing 46 and in the sleeve 50. In the first switching position of the valve device 44 according to FIG. 2a, the pass-through channels 52 of the first material inlet 24 and of the second material outlet 40 are opened, while the pass-through channels 52 of the second material inlet 26 and of the first material outlet 38 are closed. In the second switching position of the valve device 44 according to FIG. 2b, in contrast, the pass-through channels 52 of the second material inlet 26 and of the first material outlet 38 are opened, while the pass-through channels 52 of the first material inlet 24 and of the second material outlet 40 are closed.

While the slider 48 is already sufficiently sealed off by means of its precise-fit insertion into the sleeve 50, five sealing rings 54 are inserted between the sleeve 50 and the valve housing 46, which rings seal off the pass-through channels 52 from one another and from the environment. The valve housing 46 is composed of multiple housing parts, which is not shown in detail in the drawing, which parts are joined together, following one another in the axial direction, and firmly connected to one another. The sleeve 50 has two parts, with two sleeve parts that are joined together in the axial direction, while the slider 48 is in one piece with a circular cross-section.

The conveying apparatus 12 furthermore has a path measurement sensor 56 with which the position of the conveying piston 18 with reference to the conveying cylinder 16 can be determined. In this regard, the conveying piston 18 is guided on a piston rod 58 that runs axially centrally through the conveying cylinder 16, which rod penetrates the conveying piston 18 axially. The conveying piston 18 is provided with a permanent-magnet element 60, while the piston rod 58 has a magnetostrictive element 62 in which the permanent-magnet element 60 induces a magnetostriction. Furthermore, an evaluation unit 64 is provided, which evaluates the induced magnetostriction and transmits data to a control unit that is not shown in detail. The path measurement sensor 56 can recognize, for example, when one of the chambers 20, 22 has been emptied, so that the control unit can control the valve device 44 so as to bring it into a different switching position. Furthermore, the path measurement sensor 56 can measure a speed of the conveying piston 18 in the conveying cylinder 16, so that the control unit can furthermore control the flow of the conveyed material.

The regulation apparatus 15 according to the invention (FIG. 4) has a housing 70 through which a material line 72 connected to the feed line 42 runs to the applicator 14. The applicator 14 has a nozzle 74 having an exit opening 76 for the viscous material. It can furthermore have a closing valve that imparts an on/off function to it, or which can be controlled or regulated. Furthermore, a regulation valve 78 is arranged in the housing 70, the closing element 80 of which valve, in the form of a valve needle, can close and open the material line 72 at a valve seat 82. Furthermore, in the exemplary embodiment shown, an actuator 84 configured as a piezo-actuator is arranged in the housing 70, which actuator acts on a lever 88 at an impaction point 86, which lever can pivot about a pivot axis 90 that is fixed on the housing. The lever 88 is a one-armed lever, and a reset spring 92 facing away from the impaction point 86 engages on the lever 88, and the piezo-actuator 84 can pivot the lever 88 counter to the reset force of the spring. In this regard, the impaction point 86 is arranged very close to the pivot axis 90. A connection point 94, to which the lever 88 is connected with the closure element 80, is situated significantly farther away from the pivot axis 90, close to the free end of the lever 88. An action of the piezo-actuator 84 on the lever 88, counter to the force of the reset spring 92, leads to the closing element 80 being lifted up off the valve seat 82, while the reset spring 92 forces the closing element 80 back onto the valve seat 82 when the force of the piezo-actuator 84 is eliminated. A second pressure sensor 96 is arranged in the material line 72, downstream from the valve seat 82, which sensor measures the pressure at which the viscous material exits from the regulation valve 78. The measured pressure values are passed on to a regulation device 98, which regulates the pressure of the viscous material to a predetermined reference value, by controlling the piezo-actuator 84 as a function of the measured pressure values recorded by the second pressure sensor 96, by means of opening the regulation valve 78 more or less.

In summary, the following should be stated: The invention relates to an apparatus 12 for conveying viscous material to an applicator 14, having a conveying cylinder 16 in which a dual-action conveying piston 18 can be moved back and forth, wherein the conveying cylinder 16 has a first and a second chamber 20, 22, which are separated from one another by means of the conveying piston 18, wherein each of the chambers 20, 22 has a material inlet 24, 26 and a material outlet 38, 40, having a conveying device 30 connected to the material inlets 24, 26, for pressure-impacted introduction of viscous material into the chambers 20, 22 of the conveying cylinder 16, and having a valve device 44 for closing and opening the material inlets 24, 26 and the material outlets 38, 40. According to the invention, it is provided that the valve device 44 opens the material inlet 24 of the first chamber 20 and the material outlet 40 of the second chamber 22 and closes the material inlet 26 of the second chamber 22 and the material outlet 38 of the first chamber 20 in a first switching position, and opens the material inlet 26 of the second chamber 22 and the material outlet 38 of the first chamber 20 and closes the material inlet 24 of the first chamber 20 and the material outlet 40 of the second chamber 22 in a second switching position.

1: An apparatus for conveying viscous material to an applicator (14), having a conveying cylinder (16) in which a dual-action conveying piston (18) can be moved back and forth, wherein the conveying cylinder (16) has a first and a second chamber (20, 22), which are separated from one another by means of the conveying piston (18), wherein each of the chambers (20, 22) has a material inlet (24, 26) and a material outlet (38, 40), having a conveying device (30) connected to the material inlets (24, 26), for pressure-impacted introduction of viscous material into the chambers (20, 22) of the conveying cylinder (16), and having a valve device for closing and opening the material inlets (24, 26) and the material outlets (38, 40), wherein the valve device (44) opens the material inlet (24) of the first chamber (20) and the material outlet (40) of the second chamber (22) and closes the material inlet (26) of the second chamber (22) and the material outlet (38) of the first chamber (20) in a first switching position, and opens the material inlet (26) of the second chamber (22) and the material outlet (38) of the first chamber (20) and closes the material inlet (24) of the first chamber (20) and the material outlet (40) of the second chamber (22) in a second switching position.

2: The apparatus according to claim 1, wherein the valve device has a valve housing (46) and a slider (48) that can move back and forth in the valve housing (46), wherein the valve housing (46) and the slider (48) define a pass-through channel (52) that can be closed and opened for each of the material inlet openings (24, 26) and for each of the material outlet openings (38, 40), and wherein in the first switching position of the valve device (44), the slider (48) opens the pass-through channels (52) of the material inlet (24) of the first chamber (20) and of the material outlet (40) of the second chamber (22), and closes the pass-through channels (52) of the material inlet (26) of the second chamber (22) and of the material outlet (38) of the first chamber (20), and, in the second switching position of the valve device (44), opens the pass-through channels (52) of the material inlet (26) of the second chamber (22) and of the material outlet (38) of the first chamber (20) and closes the pass-through channels (52) of the material inlet (24) of the first chamber (20) and of the material outlet (40) of the second chamber (22).

3: The apparatus according to claim 2, wherein the slider (48) has a cylindrical shape and, in particular, the shape of a circular cylinder.

4: The apparatus according to claim 2, wherein the valve housing (46) has multiple parts, having several housing parts set against one another in the axial direction.

5: The apparatus according to claim 2, wherein the valve device has a sleeve (50) that is inserted into the valve housing (46), into which sleeve the slider (48) is inserted with precise fit.

6: The apparatus according to claim 1, further comprising a path measurement sensor (56) for detection of the position of the conveying piston (18) in the conveying cylinder (16).

7: The apparatus according to claim 6, wherein the path measurement sensor (56) has a permanent-magnet element (60) that is firmly connected to the conveying piston (18), a magnetostrictive element (62) that is firmly connected to the conveying cylinder (16), and an evaluation unit (64) for evaluating the magnetostriction induced by the permanent-magnet element (60) in the magnetostrictive element (62).

8: The apparatus according to claim 6, further comprising a control unit that controls the valve device (44) and/or a conveying pump (32) of the conveying device (30) as a function of the position data received from the path sensor (56).

9: The apparatus according to claim 1, wherein the valve device opens both material outlets (38, 40) and/or both material inlets (24, 26), at least in part, in at least one intermediate position.

10: A regulation apparatus for regulating the flow and/or the pressure of a viscous material, having a housing (70), having a material line (72) that runs through the housing (70), having a regulation valve (78) arranged in the housing (70) for closing the material line (72) by means of setting a closing element (80) onto a valve seat (82) and for opening the material line (72) by means of lifting the closing element (80) off from the valve seat (82), and having an actuator (84) arranged in the housing (70) for impacting the closing element (80), further comprising a force transfer element that is connected to the closing element (80) at a connection point (94), wherein the actuator (84) impacts the force transfer element at an impaction point (86).

11: The regulation apparatus according to claim 10, wherein the force transfer element is a lever (88) that is mounted so as to pivot in or on the housing (70) about a pivot axis (90).

12: The regulation apparatus according to claim 11, wherein the actuator is a piezo-actuator, and wherein the impaction point (86) lies closer to the pivot axis (90) than the connection point (94) does.

13: The regulation apparatus according to claim 11, wherein the actuator (84) has a plunger coil and the connection point (84) lies closer to the pivot axis (90) than the impaction point (86) does.

14: The regulation apparatus according to claim 10, wherein the force transfer element is a hydraulic element and that wherein the actuator (84) is a piezo-actuator.

15: The regulation apparatus according to claim 10, wherein a pressure sensor (96) for measuring the pressure of the viscous material is arranged in the material line (72).

16: The regulation apparatus for regulating the flow and/or the pressure of a viscous material, having a housing (70), having a material line (72) that runs through the housing (70), having a regulation valve (78) for closing the material line (72) by means of setting a closing element (80) onto a valve seat (82) and for opening the material line (72) by means of lifting the closing element (80) off from the valve seat (82), and having an actuator (84) for impacting the closing element (80), wherein a pressure sensor (96) for measuring the pressure of the viscous material is arranged in the material line (72).

17: The regulation apparatus according to claim 15, wherein the pressure sensor (96) is arranged downstream after the valve seat (82).

18: The regulation apparatus according to claim 15, further comprising a regulation unit (98) that is connected to the pressure sensor (96) and that regulates the pressure of the viscous material at the pressure sensor (96) to a reference value by controlling the actuator (84) as a function of the pressure measured by the pressure sensor (96).

19: An apparatus for applying viscous material to workpieces, having the apparatus (12) for conveying viscous material according to claim 1, having a regulation apparatus (15), and having an applicator (14) that has a nozzle (74) that has at least one exit opening (76) for the viscous material,
wherein the regulation apparatus (15) comprises:
a housing (70),
a material line (72) that runs through the housing (70),
a regulation valve (78) arranged in the housing (70) for closing the material line (72) by setting a closing element (80) onto a valve seat (82) and for opening the material line (72) by lifting the closing element (80) off from the valve seat (82),
an actuator (84) arranged in the housing (70) for impacting the closing element (80), and
a force transfer element that is connected to the closing element (80) at a connection point (94), wherein the actuator (84) impacts the force transfer element at an impaction point (86).

20: A method for applying viscous material to workpieces, using the regulation apparatus (15) according to claim 18, wherein the regulation unit (98) regulates the pressure of the viscous material at the pressure sensor (96) to a reference value by means of controlling the actuator (84) as a function of the pressure measured by the pressure sensor (96).

21: The method for applying viscous material to a workpiece according to claim 20, using an apparatus (10) comprising an apparatus (12) for conveying viscous material, a regulation apparatus (15), and an applicator (14) that has a nozzle (74) that has at least one exit opening (76) for the viscous material, wherein the control unit controls the valve device (44) and/or the conveying pump (32) so as to achieve a continuous material flow.

22: A method for conveying viscous material, using the apparatus (12) according to claim 8, wherein the control unit controls the valve device (44) and/or the conveying pump (32) so as to achieve a continuous material flow.
